(19) United States
(12) Patent Application Publication
(10) Pub. No.: US 2020/0199421 A1
(43) Pub. Date: Jun. 25, 2020

(54) PHYSICALLY CROSSLINKABLE COMPOSITION

(71) Applicant: 3M INNOVATIVE PROPERTIES COMPANY, St. Paul, MN (US)

(72) Inventors: Stefan H. Gryska, Woodbury, MN (US); Joon Chatterjee, Bloomington, MN (US); Babu N. Gaddam, Woodbury, MN (US)

(21) Appl. No.: 16/637,677

(22) PCT Filed: Aug. 14, 2018
(86) PCT No.: PCT/IB2018/056110

§ 371 Date: Feb. 7, 2020

Related U.S. Application Data
(60) Provisional application No. 62/557,985, filed on Sep. 13, 2017.

(51) Int. Cl. C09J 151/00; C08F 265/06; C09J 4/06

(52) U.S. Cl. CPC C09J 151/003; C08F 265/06; C09J 2451/00; C08F 2800/20; C09J 4/06

(57) ABSTRACT

Described is a polymerizable composition comprising (meth)acrylate ester monomer, a macromer and a polymerizable Norrish type I, photoinitiator. The resulting copolymers are physically crosslinked and generally those copolymers having greater than 20 percent macromer produce optically clear films and those having less than 20% macromer can provide high performance pressure sensitive adhesives.

### BACKGROUND

Acrylic pressure sensitive adhesives (PSAs) have emerged as the product of choice in a variety of end-use applications where color, clarity, permanency, weatherability, versatility of adhesion, or the chemical characteristics of an all acrylic polymer is required. These applications include a variety of consumer, packaging, industrial and health care tapes, paper and film labels, decals, bumper stickers, and the like.

Normally tacky pressure-sensitive adhesive (“psa”) compositions suitable, for example, for use in adhesive tapes must have a requisite fourfold balance of adhesion, cohesion, stretchiness and elasticity. Psa coated tapes have been produced for at least a half a century. Early psa tapes were expected to at least temporarily adhere to the surface upon which they were adhered and certain minor problems such as adhesive failure, discoloration, cohesive failure, etc. were tolerated. As psas became more sophisticated, mainly because of research in this area, the expectation level of the performance of the psa on coated tapes reached an extremely high level.

Some psa compositions desirably have transparency and resistance to sunlight aging even on exposure to severe weather conditions. With environmental considerations being more important, solvent-free processability is also a desired but often elusive feature.

Many block copolymers have psa properties and have cohesive strength and hot melt processability, but they do not have the oxidative resistance or the optical clarity of the acrylic ester adhesives. Various references teach block copolymer psa compositions, but not how to improve the latter properties. Instead, Harlan (U.S. Pat. No. 3,239,478) teaches how “oil-tolerant” they can be, Korpman (U.S. Pat. No. 3,625,752) and Downey (U.S. Pat. Nos. 3,880,953 and 3,954,692) teach how to improve adhesion through use of specifically formulated tackifiers, and Freeman (U.S. Pat. No. 4,102,835) and Korpman (U.S. Pat. No. 4,136,071) use combinations of ABA and AB copolymers to extend the range of performance.

U.S. Pat. No. 4,554,324 (Husman et al.) discloses acrylate copolymer pressure sensitive adhesive compositions having A and C monomers and optionally, B monomers. The A monomers are alkyl acrylate monomers, the C monomers are macromonomers (referred here onwards as macromer), and the optional B monomers are polar monomers copolymerizable with the A monomers.

Psa systems which by their nature are adhesives which have an extremely delicate balance of properties known in the trade as the “fourfold” balance of adhesion, cohesion, stretchiness and elasticity are described in U.S. Pat. No. 2,884,176. The desire to maintain this balance of properties makes it extremely difficult to improve internal strength, i.e., the cohesiveness without also upsetting the other properties and destroying the overall pressure-sensitive nature of the adhesive system.

The prior art relating to “graft” copolymers does not deal with psa systems. The prior art related to “graft” copolymers is directed to modifying systems which are not pressure-sensitive and for purposes diametrically opposed to the teaching of the present application. The patents of Behrens (U.S. Pat. No. 3,004,958), Gregorian (U.S. Pat. No. 3,135,717), Milkovich (U.S. Pat. Nos. 3,786,116; 3,832,423; 3,862,267) teach how to graft side chains of polystyrene or acrylate esters onto rigid or semi-rigid backbones ofpolyvinyl chloride or methacrylate polymers to provide flexibility and temperature and impact resistance. Harlan (U.S. Pat. No. 4,007,311) shows that grafting methyl methacrylate to a styrene-isoprene-styrene block copolymer enhances adhesion without regard for elasticity or cohesiveness. In Ambrose (U.S. Pat. No. 4,075,186), a butadiene side chain is grafted to an acrylate polymer backbone to produce a molding material which has improved electrical properties and impact resistance but which is tack-free.

An acrylic psa having versatile processing capabilities and improved shear strength, to applicants' knowledge, is not known. Applicants herein teach the preparation of such an adhesive without sacrificing the outstanding optical clarity and resistance to oxidative and photochemical forces of the acrylic ester copolymer backbone.

### SUMMARY

The present invention relates to a polymerizable composition comprising (meth)acrylate ester monomer, a macromer and a polymerizable Norrish type I, photoinitiator. The resulting copolymers are physically crosslinked and are in many embodiments are optically clear. The copolymers having greater than 20 percent macromer produce optically clear films and those having less than 20% macromer can provide high performance pressure sensitive adhesives. These copolymers may be compounded with tackifiers and plasticizers that will influence the properties while lowering the melt viscosity into a desirable range. The invention provides significant property enhancements for copolymers having poor peel and shear adhesive properties. The acrylic backbone is tailored by judicious selection of acrylic comonomers in order to allow compounding with additives that provide balanced adhesive properties while ensuring long term weatherbility and durability.

The pressure-sensitive adhesives of this disclosure provide the desired balance of tack, peel adhesion, and shear holding power, and further conform to the Dahlquist criteria; i.e. the modulus of the adhesive at the application temperature, typically room temperature, is less than 3×10⁶ dynes/cm at a frequency of 1 Hz. In particular, the instant adhesive compositions have high cohesive strength in the absence of crosslinking agents.

In some embodiments, adhesive compositions are provided which applied to substrates from the melt. Such hot melt adhesive compositions are substantially solvent-free. Hot melt adhesives are versatile and widely used in industrial applications, such as book bindings, cardboard boxes, plastic parts and wooden articles, among others. They are generally 100% solid adhesives with application temperatures which vary from about 150 to about 180° C.

The adhesive compositions of the present disclosure provide an improved pressure-sensitive and hot-melt adhesive composition which may be adhered to a variety of substrates, including low surface-energy (LSE) substrates, within a wide temperature range and provide good adhesive strength and holding characteristics. The adhesive compositions are easily handled, and are environmentally friendly due to the low volatile organic compound (VOC) content, such as solvents. The adhesive compositions of the present disclosure further provide a pressure-sensitive adhesive article, such as adhesive tapes and sealants.

### BRIEF DESCRIPTION OF THE DRAWINGS

FIG. 1 is the DMA analysis of Comparative Example CE-3 and Examples 2 and 5

FIG. 2 is the DMA analysis of Comparative Example CE-3 and Examples 8 and 10

### DETAILED DESCRIPTION

The macromer useful in the practice of this invention is a polymeric moiety having a vinyl group which will copolymerize with the alkyl (meth)acrylate monomer, and optional additional monomers.

The macromonomer is represented by the general formula

X—(Y)ₙ—Z (I)

wherein X is a vinyl group copolymerizable with the alkyl acrylate and reinforcing monomers;
Y is a divalent linking group where n can be zero or one, and
Z is a monovalent polymeric moiety having a T_{g} greater than 20° C., a number average molecular weight in the range of about 2,000 to about 30.000, and being essentially unreactive under copolymerization conditions. Z is preferably selected from oligomeric styrene, p-methyl-styrene, poly(methyl methacrylate) and macromers of high T_{g} monomers, as describe further herein.

The preferred macromonomer is further defined as having an X group with the general formula

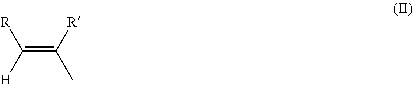

wherein R is a hydrogen atom and R′ is a hydrogen atom or methyl group. The double bond between the carbon atoms provides a moiety capable of copolymerizing with the alkyl acrylate and reinforcing monomers.

The preferred macromer includes a Z group which has the formula

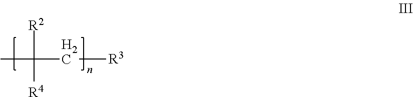

wherein R² is a hydrogen atom or a lower alkyl group, R³ is a lower alkyl group, n is an integer from 20 to 500, and R⁴ is a monovalent radical selected from the group consisting of aryl including substituted aryl and —CO₂R⁶ wherein R⁶ is a lower alkyl group.

Preferably, the macromer has the general formula selected from the group consisting of

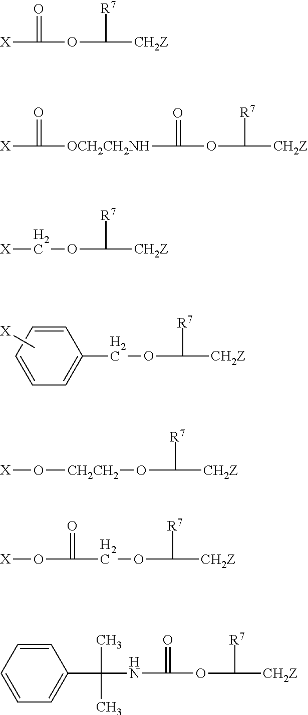

wherein R⁷ is a hydrogen atom or a lower alkyl group.

The vinyl-terminated polymeric macromonomers may be prepared by the method disclosed in U.S. Pat. Nos. 3,786,116 and 3,842,059 (Milkovich et al.), incorporated herein by reference.

The amount of macromer that is useful varies from greater than about 1 to about 30 parts by weight per 100 parts by weight of the total amount by weight of the (meth)acrylate monomer, the photoinitiator monomers, the optional monomers and the macromer. In many embodiments 20 parts by weight or less of the macromer results in a pressure-sensitive adhesive composition. In such embodiments the PSA composition preferably comprises from about 1 parts to less than 20 parts and preferably, from about 5 parts to about 20 parts per 100 parts by weight of the total amount by weight of the (meth)acrylate monomer, the optional monomers, and the macromonomer. Greater than 20 parts by weight results in optically clear coating compositions. By “optically clear” it is meant that the cured compositions have greater than 95% average transmissivity over the 400-700 nm range. In such embodiments the coating composition comprises greater than 20 to 30 parts by weight of the macromer, per 100 parts by weight of the total amount by weight of the (meth)acrylate monomer, the optional monomers, and the macromonomer

The curable composition comprises (meth)acrylic esters of a non-tertiary alcohol (acrylate esters), which alcohol contains from 1 to 18 carbon atoms and preferably an average of from 4 to 12 carbon atoms. A mixture of such monomers may be used. The acrylate ester monomer unit is represented as M^{acryl}.

Examples of monomers suitable for use as the (meth)acrylate ester monomer include the esters of either acrylic acid or methacrylic acid with non-tertiary alcohols such as ethanol, 1-propanol, 2-propanol, 1-butanol, 2-butanol, 1-pentanol, 2-pentanol, 3-pentanol, 2-methyl-1-butanol, 3-methyl-1-butanol, 1-hexanol, 2-hexanol, 2-methyl-1-pentanol, 3-methyl-1-pentanol, 2-ethyl-1-butanol, 3,5,5-trimethyl-1-hexanol, 3-heptanol, 1-octanol, 2-octanol, isooctylalcohol, 2-ethyl-1-hexanol, 1-decanol, 2-propylheptanol, 1-dodecanol, 1-tridecanol, 1-tetradecanol, citronellol, dihydrocitronellol, and the like. In some embodiments, the preferred (meth)acrylate ester monomer is the ester of (meth)acrylic acid with butyl alcohol or isooctyl alcohol, or a combination thereof, although combinations of two or more different (meth)acrylate ester monomer are suitable.

In some embodiments, the (meth)acrylate ester component may comprise a high Tg monomer. The adhesive copolymer further comprises grafted monomer units of high T_{g} monomers or macromers. As used herein the term “high T_{g} monomer” refers to a monomer, which when homopolymerized, produce a (meth)acrylate copolymer having a T_{g} of ≥50° C. as estimated by the Fox equation. The incorporation of the high T_{g} monomer to copolymer is sufficient to provide glassy segments to the copolymer. The high T_{g} group is represented in the copolymer of Formula I as M^{HighTg}.

Suitable high T_{g} monomers include, but are not limited to, t-butyl acrylate, methyl methacrylate, ethyl methacrylate, isopropyl methacrylate, n-butyl methacrylate, isobutyl methacrylate, s-butyl methacrylate, t-butyl methacrylate, stearyl methacrylate, phenyl methacrylate, cyclohexyl methacrylate, isobornyl acrylate, isobornyl methacrylate, benzyl methacrylate, 3,3,5 trimethylcyclohexyl acrylate, cyclohexyl acrylate, N-octyl acrylamide, and propyl methacrylate or combinations.

In some embodiments, the preferred (meth)acrylate ester monomer is the ester of (meth)acrylic acid with an alcohol derived from a renewable source, such as 2-octanol, citronellol, dihydrocitronellol.

In some embodiments a portion of the above described (meth)acrylate esters may be substituted with (meth)acrylates derived from 2-alkyl alkanols (Guerbet alcohols) as described in U.S. Pat. No. 8,137,807 (Lewandowski et al.), incorporated herein by reference.

The (meth)acrylate ester monomer is present in an amount of 70 parts by weight based on 100 parts total monomer content in the monomer mixture. Preferably (meth)acrylate ester monomer is present in an amount of ≥90 parts by weight, most preferably ≥95 parts by weight parts by weight, based on 100 parts total monomer content. Generally the amount of (meth)acrylate monomer is less than 99 parts by weight.

The polymerizable composition may further comprise a polar monomer designated M^{polar} in Formula I. The polar monomers useful in preparing the copolymer are both somewhat oil soluble and water soluble, resulting in a distribution of the polar monomer between the aqueous and oil phases in an emulsion polymerization. As used herein the term “polar monomers” are inclusive of acid functional monomers.

Representative examples of suitable polar monomers include but are not limited to 2-hydroxyethyl (meth)acrylate; N-vinylpyrrolidone; N-vinylcaprolactam; acrylamide; mono- or di-N-alkyl substituted acrylamide; t-butyl acrylamide; dimethylaminoethyl acrylamide; N-octyl acrylamide; poly(alkoxyalkyl) (meth)acrylates including 2-(2-ethoxyethoxy)ethyl (meth)acrylate, 2-ethoxyethyl (meth)acrylate, 2-methoxyethoxyethyl (meth)acrylate, 2-methoxyethyl methacrylate, polyethylene glycol mono(meth)acrylates; alkyl vinyl ethers, including vinyl methyl ether; and mixtures thereof. Preferred polar monomers include those selected from the group consisting of 2-hydroxyethyl (meth)acrylate and N-vinylpyrrolidinone.

The polar monomer of the copolymer may comprise an acid functional monomer, where the acid functional group may be an acid per se, such as a carboxylic acid, or a portion may be a salt thereof, such as an alkali metal carboxylate. With regard to Formula VI (below), M^{polar} may be designated as M^{acid} when acid functional monomers are used

Useful acid functional monomers include, but are not limited to, those selected from ethylenically unsaturated carboxylic acids, ethylenically unsaturated sulfonic acids, ethylenically unsaturated phosphonic or phosphoric acids, and mixtures thereof. Examples of such compounds include those selected from acrylic acid, methacrylic acid, itaconic acid, fumaric acid, crotonic acid, citraconic acid, maleic acid, oleic acid, 3-carboxyethyl (meth)acrylate, 2-sulfoethyl methacrylate, styrene sulfonic acid, 2-acrylamido-2-methylpropanesulfonic acid, vinylphosphonic acid, and mixtures thereof.

The polar monomer may be present in amounts of 0 to 10 parts by weight, preferably 0.1-5 parts by weight, based on 100 parts by weight total monomer. With reference to the copolymer of Formula I, subscript c reflects these amounts, so c may be zero or non-zero, or a normalized, non-integral value.

The curable composition further comprises photoinitiator monomers, [M^{PI}] include a (meth)acryloyl group and a photoinitiator group, which may be a hydrogen-abstracting type or an α-cleavage-type photoinitiator group, (Norrish Type I and II) and may be represented by the formula:

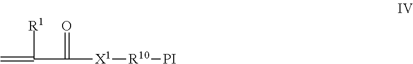

where;
X¹ is —O— or —NR¹,
R¹ is independently H or C₁-C₄ alkyl;
R¹⁰ is a divalent (hetero)hydrocarbyl linking group connecting the (meth)acryloyl group with the PI group; and
PI is a photoinitiator which may be represented by the structure:

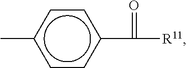

wherein R¹¹ is

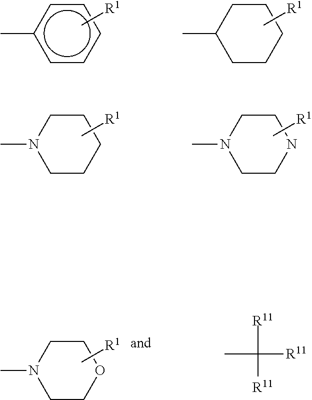

wherein R¹ is H or a C₁ to C₄ alkyl group,
each R¹¹ is independently a hydroxyl group, a phenyl group, a C₁ to C₆ alkyl group, or a C₁ to C₆ alkoxy group. Such photoinitiator monomers are described, for example, in U.S. Pat. No. 5,902,836 (Babu et al.) and 5,506,279 (Babu et al.), the disclosures of which are herein incorporated by reference. Further details regarding the linking R¹⁰ group may be found with reference to the cited references.

A variety of photoinitiator grafting monomers can be made by reaction of: 1) an acryloyl monomer comprising a first reactive functional group with 2) a compound that comprises a radiation-sensitive group (photoinitiator group) and second reactive functional group, the two functional groups being co-reactive with each other. Preferred co-reactive compounds are ethylenically unsaturated aliphatic, cycloaliphatic, and aromatic compounds having up to 36 carbon atoms, optionally one or more oxygen and/or nitrogen atoms, and at least one reactive functional group. When the first and second functional groups react, they form a covalent bond and link the co-reactive compounds.

Examples of useful reactive functional groups include hydroxyl, amino, oxazolinyl, oxazolonyl, acetyl, acetonyl, carboxyl, isocyanato, epoxy, aziridinyl, acyl halide, and cyclic anhydride groups. Where the first reactive functional group is an isocyanato functional group, the second, co-reactive functional group preferably comprises a amino, carboxyl, or hydroxyl group. Where first reactive functional group comprises a hydroxyl group, the second, co-reactive functional group preferably comprises a carboxyl, isocyanato, epoxy, anhydride, acyl halide, or oxazolinyl group. Where the first reactive functional group comprises a carboxyl group, the second co-reactive functional group preferably comprises a hydroxyl, amino, epoxy, vinyloxy, or oxazolinyl group.

Representative examples of acrylate compounds having a reactive functional group include hydroxyalkyl acrylates such as 2-hydroxyethyl acrylate and 2-(2-hydroxyethoxy)ethyl acrylate; aminoalkyl acrylates such as 3-aminopropyl acrylate; oxazolonyl compounds such as 2-ethenyl-1,3-oxazolin-5-one and 2-propenyl-4,4-dimethyl-1,3-oxazolin-5-one; carboxy-substituted compounds such as acrylic acid and 4-carboxybenzyl acrylate; isocyanato-substituted compounds such as isocyanatoethyl acrylate and 4-isocyanatocyclohexyl acrylate; epoxy-substituted compounds such as glycidyl acrylate; aziridinyl-substituted compounds such as N-acryloylethylaziridine; and acryloyl halides.

Representative examples of co-reactive compounds include functional group-substituted compounds such as 1-(4-hydroxyphenyl)-2,2-dimethoxyethanone, 1-[4-(2-hydroxyethyl)phenyl]-2,2-dimethoxyethanone, (4-isocyanatophenyl)-2,2-dimethoxy-2-phenylethanone, 1-{4-[2-(2,3-epoxypropoxy)phenyl] }-2,2-dimethyl-2-hydroxyethanone, 1-[4-(2-aminoethoxy)phenyl]-2,2-dimethoxyethanone, and 1-[4-(carbomethoxy)phenyl]-2,2-dimethoxyethanone.

A preferred photoinitiator monomer is to 2-propenoylaminoethanoic acid, 2-(4-(2-hydroxy-2 methylpropanoyl)phenoxy)ethyl ester, “VAZPIA” prepared according to Example 1 of U.S. Pat. No. 5,506,279 (Babu et al.).

The photoinitiator monomers are used in amounts of 0.1 to 10, preferably 0.1 to 5 parts by weight, relative to 100 parts by weight total monomer.

### Polymerization.

Polymerization techniques include, but are not limited to, the conventional techniques of solvent polymerization, dispersion polymerization, and solventless bulk polymerization. Solvent polymerization is preferred

A typical solution polymerization method is carried out by adding the monomers, a suitable solvent, and an optional chain transfer agent to a reaction vessel, adding a free radical initiator, purging with nitrogen, and maintaining the reaction vessel at an elevated temperature, typically in the range of about 40 to 100° C. until the reaction is completed, typically in about 1 to 20 hours, depending upon the batch size and temperature. Examples of the solvent are tetrahydrofuran, acetone, methyl ethyl ketone, methyl acetate, ethyl acetate, toluene, xylene, and an ethylene glycol alkyl ether. Those solvents can be used alone or as mixtures thereof.

If desired, the molecular weight, Mw, of the resulting copolymer such as are shown in the following reaction schemes may be controlled with the use of chain transfer agents. Chain transfer agents which may be used are those generally considered as low activity. In many embodiments the composition may be polymerized to conversions of up to about 75% without gelation.

Chain transfer can be represented as a competition between the monomer and the transfer agent for propagating polymer radicals. Where kₜᵣ is the rate constant of the transfer reaction, and kₚ is the rate constant of the propagation reaction, the chain transfer constant Cₜᵣ is the ratio of the chain transfer rate constant, kₜᵣ and the propagation rate constant kₚ: Cₜᵣ=kₜᵣ/kₚ. The chain transfer constant can be determined graphically using the Mayo equation, where (1/Xₙ)=(1/Xₙ)₀+Cₜᵣ [S]/[M], in which Cₜᵣ is determined as a slope of the linear plot of the reciprocal of the degree of polymerization (1/Xₙ) versus the ratio of the initial concentration of transfer agent to monomer concentration [S]/[M], and wherein (1/Xₙ)₀ is the degree of polymerization obtained in the absence of the chain transfer agent. With respect to the above equation, useful chain transfer agents have a kₜᵣ<<kₚ. Most useful chain transfer agents have a chain transfer constant (Cₜᵣ) of between 10⁻² and 10⁻⁵ when measured for butyl acrylate monomer. Note many common solvents such as isopropanol have chain transfer constants in the desired range.

Useful chain transfer agents may include isopropanol, 2-ethoxtethanol, allyl alcohol, and α-olefins such as hexane and octane.

This equation is valid only when the initiator concentration is low. By synthesizing a series of polymers with different ratios of chain transfer agent to monomer, a Mayo plot can be used to determine the Cₜᵣ. Knowledge of the Cₜᵣ for a particular system enables one to adjust the reactant concentrations in order to target a specific molar mass polymer. (See e.g., pages 226-233 of a text entitled Principles of Polymerization, second edition, by George Odian, published 1981 by John Wiley & Sons, Inc.)

In general, the component of the curable composition are combined and irradiated with activating UV radiation to photolyse the photoinitiator group and polymerize the monomers and macromer component(s) to produce the adhesive copolymer. The degree of conversion (of monomers or macromers to grafted copolymer) can be monitored during the irradiation by measuring the index of refraction of the polymerizing mixture.

UV light sources can be of two types: 1) relatively low light intensity sources such as backlights which provide generally 10 mW/cm² or less (as measured in accordance with procedures approved by the United States National Institute of Standards and Technology as, for example, with a Uvimap™ UM 365 L-S radiometer manufactured by Electronic Instrumentation & Technology, Inc., in Sterling, Va.) over a wavelength range of 280 to 400 nanometers and 2) relatively high light intensity sources such as medium pressure mercury lamps which provide intensities generally greater than 10 mW/cm², preferably between 15 and 450 mW/cm². For example, an intensity of 600 mW/cm² and an exposure time of about 1 second may be used successfully. Intensities can range from about 0.1 to about 150 mW/cm², preferably from about 0.5 to about 100 mW/cm², and more preferably from about 0.5 to about 50 mW/cm². Such photoinitiators preferably are present in an amount of from 0.1 to 1.0 pbw per 100 pbw of the polymer composition.

In a first embodiment the composition may be polymerized by combining the components and irradiating, whereby the photoinitiator groups photolyze and initiate free radical addition/polymerization of the (meth)acrylate monomer(s), photoinitiator monomer, optional polar monomer(s) and the macromer. It will be apparent that the photoinitiator monomer is capable of initiating the polymerization through the photoinitiators groups, and propagating the polymerization from the polymerizable group.

The reactivity of the macromer is much lower than the alkyl acrylate monomers. The macromers in general have less tendency to undergo homopropagation.

As the macromer is generally less efficient at propagating the polymerization, the macromers tend to terminate the propagating radical chains. In some embodiments it is advantageous to use low reactivity chain transfer agent such as isopropanol to prevent gelation, as describe further herein.

The reaction of the first embodiment may be illustrated as follows where M^{acryl} is an acrylic monomer, M^{macro} is the macromer and M^{PI} is the polymerizable PI. For simplicity, other optional monomers are not shown. In the scheme, the sum of the subscripts a represents 70 to 99 parts by weight of a (meth)acrylate ester monomer units, subscript b represents 0.1-10 parts by weight of monomer units derived from a polymerizable type I photoinitiator, preferably 0.1-5 parts by weight, and subscripts c+d represent 1 to 30 parts by weight of a copolymerizable macromer, wherein a)+b)+c)+d) is 100 parts by weight. We don't need to be explicit Note that the M^{PI} monomer units may be part of the main chain or may result in a branch point from photolysis of the photoinitiator group. The M^{macro} units may be at the terminus of the chains due to the lower reactivity. Note the reaction product may include unreacted macromer, unreacted polymerizable photoinitiator and unreacted (meth)acrylate monomer.

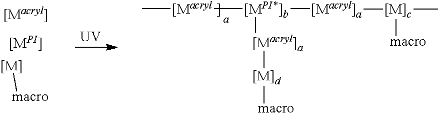

In a second embodiment, the composition is polymerized in a two-step process whereby the polymerizable photoinitiator, (meth)acrylate monomer(s), optionally macromers, and polar monomers are first polymerized thermally to a (meth)acrylate copolymer having pendent photoinitiator groups. If the macromer is absent from the initial polymerization mixture, the resulting copolymer may be further combined with the macromer (and optionally additional (meth)acrylate monomer and polar monomer) and photopolymerized to provide branched copolymer with macromer graft chains to the branches. If the macromer is present in the thermal polymerization mixture, it largely terminates the macroradical chains

The reaction of the second embodiment may be illustrated as follows, where M^{acryl} is an acrylic monomer, M^{macro} is the macromer and M^{PI} is the polymerizable PI. For simplicity, other optional monomers are not shown.

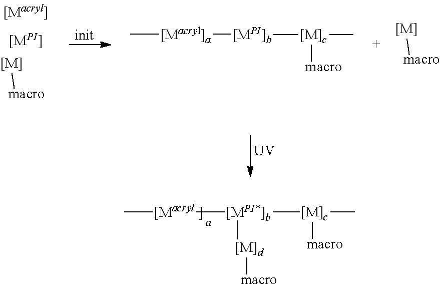

With regard to the above scheme, subscript a represents 70 to 99 parts by weight of a (meth)acrylate ester monomer units, subscript b represents 0.1-10 parts by weight of monomer units derived from a polymerizable type I photoinitiator, preferably 0.1-5 parts by weight, and subscripts c+d represent 1 to 30 parts by weight of a copolymerizable macromer, wherein a)+b)+c)+d) is 100 parts by weight. The copolymer may be further represented as

-[M^{acryl}]ₐ-[M^{PI*}]_{b}-[M^{macro}]_{c+d}*[M^{polar}]ₑ, (VI)

where
[M^{acryl}] represents (meth)acrylic monomer units in amounts of subscript 70 to <99 parts by weight,
[M^{PI*}] are monomer units having a residue of the photoinitiator groups in amounts of 0.1-10 parts by weight;
[M^{macro}] is the macromer monomer units that are pendent from the MPI* monomer units represented in subscript c amounts or are in-chain represent in subscript d amounts, where c+d is 1 to 30 parts by weight,
[M^{polar}] are optional polar monomer units in amounts subscript e of 0.1 to 10 parts by weight, wherein the sum of the subscripts is 100 parts by weight.

As result of the polymerized macromer units, the copolymer has physically crosslinks. It is believed that the macromer groups microphase separate from the main polymer chain. This microphase separation results in the formation of separate microdomains of the macromer units that function as physical crosslinks for the (meth)acrylate copolymer chain. The size of the domain appears to be less than 100A⁰ so that the films do not scatter light and provide optical clarity. The copolymer can be used as an adhesive such as a pressure sensitive adhesive. The cohesive strength of the adhesive tends to increase with the introduction of more grafted groups.

Physical crosslinking typically relies on the natural or induced formation of entanglements within the grafted polymeric chains and tends to increase the cohesive strength of adhesive compositions such as pressure-sensitive adhesive compositions. Physical crosslinking is often desired because the pressure-sensitive adhesive can be processed in a melted state at relatively high temperatures yet can take on a crosslinked form at lower temperatures. That is, the pressure-sensitive adhesives can be used as hot melt adhesives. In contrast, chemical crosslinked pressure-sensitive adhesives typically cannot be processed as hot melt adhesives. Hot melt processing is often considered desirable because the use of inert organic solvents can be minimized or eliminated. The minimization or elimination of inert organic solvents can be desirable from both an environmental and economic perspective.

Physical crosslinking is enhanced when the macromer group has a glass transition temperature greater than or equal to at least 30° C. To form such a copolymeric group, the monomers used are selected to have a glass transition temperature equal to at least 30° C. (when polymerized as a homopolymer and as estimated by the Fox equation).

In addition to the glass transition temperature, the molecular weight of the macromer group can affect whether or not the copolymer of Formula I will phase separate and physically crosslink. Phase separation is more likely if number of repeat units of a given grafted group is at least 10. It will be appreciated that the photoinitiated polymerization is essentially uncontrolled, and a range of repeat units (subscript e of Formula I) will be present. However, the copolymer of Formula I is prepared with a sufficient number of photoinitiator monomer units, and then copolymerized with a sufficient amount of macromers, such that the macromer groups will phase separate to effect physical crosslinking. Generally, at least 10% of the macromer groups have at least ten repeat units; at least ten percent of subscript e is ten or more, and is less than 50.

If the molecular weight of the macromergroups becomes too large (i.e. the number of repeat units is too large), the number of grafted polymer groups formed on a weight basis by reaction with the main polymer chain may be diminished. That is, as the molecular weight of the macromer increases, it can become more difficult to achieve a high degree of incorporation of macromergroups on a weight basis in the copolymer.

The pressure-sensitive adhesives may optionally contain one or more conventional additives. Preferred additives include tackifiers, plasticizers, dyes, antioxidants, UV stabilizers, and (e.g. inorganic) fillers such as (e.g. fumed) silica and glass bubbles. In some embodiments no tackifier is used. When tackifiers are used, the concentration can range from 5 or 10, 15 or 20 wt. % or greater of the adhesive composition.

Various types of tackifiers include phenol modified terpenes and rosin esters such as glycerol esters of rosin and pentaerythritol esters of rosin that are available under the trade designations “Nuroz”, “Nutac” (Newport Industries), “Permalyn”, “Staybelite”, “Foral” (Eastman). Also available are hydrocarbon resin tackifiers that typically come from C5 and C9 monomers by products of naphtha cracking and are available under the trade names “Piccotac”, “Eastotac”, “Regalrez”, “Regalite” (Eastman), “Arkon” (Arakawa), “Norsolene”, “Wingtack” (Cray Valley), “Nevtack”, LX (Neville Chemical Co.), “Hikotac”, “Hikorez” (Kolon Chemical), “Novares” (Rutgers Nev.), “Quintone” (Zeon), “Escorez” (Exxonmobile Chemical), “Nures”, and “H-Rez” (Newport Industries). Of these, glycerol esters of rosin and pentaerythritol esters of rosin, such as available under the trade designations “Nuroz”, “Nutac”, and “Foral” are considered biobased materials.

The above-described compositions are coated on a substrate using conventional coating techniques modified as appropriate to the particular substrate. For example, these compositions can be applied to a variety of solid substrates by methods such as roller coating, flow coating, dip coating, spin coating, spray coating knife coating, and die coating. These various methods of coating allow the compositions to be placed on the substrate at variable thicknesses thus allowing a wider range of use of the compositions. Coating thicknesses may vary, but coating thicknesses of 2-500 microns (dry thickness), preferably about 10 to 250 microns, are contemplated.

The substrate is selected depending on the particular application in which it is to be used. For example, the adhesive can be applied to sheeting products, (e.g., decorative graphics and reflective products), label stock, and tape backings. Additionally, the adhesive may be applied directly onto a substrate such as an automotive panel, or a glass window so that another substrate or object can be attached to the panel or window.

The adhesive can also be provided in the form of an adhesive transfer tape in which at least one layer of the adhesive is disposed on a release liner for application to a permanent substrate at a later time. The adhesive can also be provided as a single coated or double coated tape in which the adhesive is disposed on a permanent backing.

### Examples

### Materials

| Designation | Description |
|---|---|
| BA | n-Butyl acrylate, available from Alfa Assar, Ward Hill, MA |
| ACAM PI | 2-Acryloylamino-2-methyl-propionic acid 2-[4-(2-hydroxy- |
| | 2-methyl-propionyl)-phenoxy]-ethyl ester, prepared as |
| | described in U. S. Pat. No. 5,506,279 (Babu et al.). |
| E1010 | A poly(methacrylate) macromer which was determined |
| | by gel permeation chromatography (GPC) to have a |
| | weight average molecular weight of approximately |
| | 6770 grams/mole, obtained under the trade designation |
| | ELVACITE 1010 MACROMER from Lucite International, |
| | Cordova, TN. |
| E1020 | A poly(methacrylate) macromer which was determined by |
| | gel permeation chromatography (GPC) to have a weight |
| | average molecular weight of approximately 26,600 grams/ |
| | mole, obtained under the trade designation ELVACITE 1010 |
| | MACROMER from Lucite International, Cordova, TN. |
| PET Film | A polyester film having a primer treatment on one side |
| | and a thickness of 50 micrometers (0.002 inch), available |
| | under the trade designation HOSTAPHAN 3SAB from |
| | Mitsubishi Polyester Film, Incorporated, Greer, SC. |

### Test Methods

### Peel Adhesion Strength

Peel adhesion strength was measured according to ASTM D3330/D3330M-04: “Standard Test Method for Peel Adhesion of Pressure Sensitive Tape” (Reapproved 2010). After conditioning for 24 hours at 23° C. (73° F.) and 50% relative humidity (RH), tape samples measuring 12.7 millimeters (0.5 inches) wide and 20.3 centimeters (8 inches) long were cut. The tape samples were then applied to a glass plate previously wiped clean with methyl ethyl ketone (MEK), then n-heptane, and again with MEK using lint free tissues. The tape was rolled down twice in each direction using a 2 kilogram (4.4 pounds) rubber roller. After a 30 minute dwell time peel adhesion strength was then measured, under the same temperature and relative humidity as used above, at an angle of 180 degrees, a rate of 305 millimeters/minute (12 inches/minute), and over a length of 5.1 centimeters (2 inches) using a peel adhesion tester (IMASS Slip/Peel Tester, Model SP-2000, available from IMASS Incorporated, Accord, MA). Three samples were evaluated, the results normalized to ounces/inch (oz/in), and the average value reported in both ounces/inch and Newtons/decimeter. The failure mode was also noted as follows. “Adh” indicated adhesive failure where the tape removed cleanly without leaving any residue on the glass plate. “Coh” indicated cohesive failure (a splitting of the adhesive) with residue left on both the glass plate and tape backing.

### Shear Adhesion Strength

Shear adhesion strength at 23° C. and 50% relative humidity (RH) was measured according to ASTM D3654/D 3654M-06: “Standard Test Methods for Shear Adhesion of Pressure Sensitive Tapes” (Reapproved 2011). After conditioning for 24 hours at 23° C. (73° F.) and 50% relative humidity, tape samples measuring 12.7 millimeters (0.50 inches) wide and 15.2 centimeters (6 inches) long were cut. The tape samples were then applied to a stainless steel panel previously wiped clean with methyl ethyl ketone (MEK), then n-heptane, and again with MEK using lint free tissues. The samples were then centered on the panels and adhered to one end such that tape overlapped the panel by 25.4 millimeters (1 inch) in the lengthwise direction. The tape sample was then rolled down twice in each direction using a 2 kilogram (4.4 pounds) rubber roller. The free end of the tape was folded over and adhered to itself such that there was no exposed adhesive. This free end was folded over and around a hanging hook and stapled together to secure the hook in place. The resulting panel/tape/weight assembly was suspended vertically in a stand at an angle of 2 degrees to ensure a shear failure mode. A 1.0 kilogram (2.2 pounds) weight was attached to the hook and the time, in minutes, for the tape to fall from the panel was recorded along with the mode of failure: cohesive (c) in which the adhesive split and part was left on the stainless steel plate and part left on the tape backing. The test was terminated if failure had not occurred by 10,000 minutes and the result recorded as “10,000+”. The average of two samples was reported.

### Dynamic Mechanical Analysis (DMA)

Dynamic mechanical analysis was used to measure the storage modulus and glass transition temperatures of adhesives. A rheometer (Model ARES G2 RHEOMETER, TA Instruments, New Castle, Del.) having parallel top and bottom plates, each having a diameter of 8 millimeters was used. An adhesive sample in the form of a circular disk having a diameter of 8 millimeters and a thickness of approximately 1 millimeter was transferred onto the bottom plate of the rheometer. The top plate of the rheometer was brought down onto the adhesive sample and the sample was subjected to oscillatory shear while being heated from −60° C. to 200° C. at a rate of 5° C./minute at a frequency of 1 Hertz and a strain amplitude of 1%. Storage modulus (G′) and Loss Modulus (G″) data was collected over the entire temperature range and reported in Pascals. Tan delta was calculated as the ratio of (loss modulus/storage modulus)=(G″/G′). The temperature at which the tan delta curve exhibited a local peak was reported as the glass transition temperature (Tg) in ° C.

### Preparation of the Acrylamidoacetyl Photoinitiator (ACAM PI)

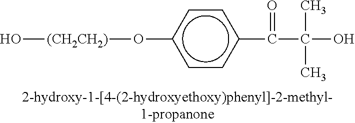

Into a 200 ml round bottom flask fitted with a magnetic stirrer were placed 22.4 g (0.1 mole) of (available as IRGACURE 2959 from Sigma-Aldrich, LLC, St. Louis, Mo.), 14.2 g (0.102 mole) of 2-vinyl-4,4-dimethyl-2-oxazolin-5-one (VDM) (available from SNPE Inc., Princeton, N.J. 08540), and 50 ml of amyl acetate. While stirring the mixture, 0.76 g of 1,8-diazabicyclo[5.4.0]undec-7-ene (DBU) (available from Aldrich Chemical Co., Milwaukee, Wis.) was added. Heat was evolved as the reaction components went into solution, and after complete solution was obtained, stirring was discontinued. The mixture was allowed to cool to room temperature and the solid that had formed was collected by filtration. After drying the recovered solid in a vacuum oven at about 40 .degree. C., there was obtained 32.6 g of reaction product (89.8% of theory). The material had a melting point of 85° C. (uncorrected). Elemental Analysis, Infrared Spectral Analysis, and proton and carbon 13 Nuclear Magnetic Resonance confirmed that the material was 2-Acryloylamino-2-methyl-propionic acid 2-[4-(2-hydroxy-2-methyl-propionyl)-phenoxy]-ethyl ester, herein referred to as ACAM PI.

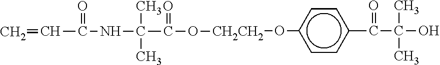

### Examples

### Examples 1-12 and Comparative Examples 1-3 (CE 1-CE 3)

The compositions of Examples 1-11 and Comparative Examples 1-3 were prepared using the materials and amounts as shown in Table 1. The compositions were based on a total monomer amount of 40 grams. The amounts shown in Table 1 are given in parts by weight (pbw). The materials were added to a 250 milliliter clear bottle and stirred until all the E1010 or E1020 was dissolved, then purged with nitrogen gas for 10 minutes at room temperature. The bottles were then sealed and placed on a rotating roller under low intensity UV light from two 40 Watt SYLVANIA 350 BLACKLIGHT (peak emission of approximately 350 nanometers) until a coatable viscosity was obtained. The polymer solutions were coated onto the primed side PET Film using a knife coater having a gap setting that was 0.005 inches (127 micrometers) greater than the film thickness then dried for 30 minutes at 70° C. (158° F.) to give pressure sensitive adhesive tape articles having an adhesive thickness of between 38 and 50 micrometers (0.0015 and 0.0020 inch). The tape articles were evaluated for their peel adhesion strength, shear adhesion strength, and rheological properties as described in the test methods. The results are reported in Tables 2 and 3.

TABLE 1
Compositions

| | nBA | ACAM PI | E1010 | E1020 | IPA* | EA* |
|---|---|---|---|---|---|---|
| Ex. | pbw | pbw | pbw | pbw | pbw | pbw |
| CE 1 | 100 | 0.2 | 0 | 0 | 0.5 | 100 |
| CE 2 | 100 | 0.2 | 0 | 0 | 2.0 | 100 |
| CE 3 | 100 | 0.2 | 0 | 0 | 5.0 | 100 |
| 1 | 95 | 0.2 | 5 | 0 | 0.5 | 100 |
| 2 | 95 | 0.2 | 5 | 0 | 2.0 | 100 |
| 3 | 95 | 0.2 | 5 | 0 | 5.0 | 100 |
| 4 | 90 | 0.2 | 10 | 0 | 0.5 | 100 |
| 5 | 90 | 0.2 | 10 | 0 | 5.0 | 100 |
| 6 | 95 | 0.2 | 0 | 5 | 0.5 | 100 |
| 7 | 95 | 0.2 | 0 | 5 | 2.0 | 100 |
| 8 | 95 | 0.2 | 0 | 5 | 5.0 | 100 |
| 9 | 90 | 0.2 | 0 | 10 | 0.5 | 100 |
| 10 | 90 | 0.2 | 0 | 10 | 2.0 | 100 |
| 11 | 90 | 0.2 | 0 | 10 | 5.0 | 100 |
| 12 | 95 | 0.2 | 5 | 0 | 0 | 100 |

*EA: ethyl acetate; IPA: isopropyl alcohol

TABLE 2
Results

| | | Peel | | Shear | |
|---|---|---|---|---|---|
| | Thickness | Adhesion Strength | | Adhesion Strength | |
| | (micro- | oz/in | failure | | failure |
| Ex. | meters) | (N/dm) | mode | minutes | mode |
| CE 1 | Not coatable | — | — | — | — |
| CE 2 | 48 | 37 | adh | 15 | coh |
| | | (40) | | | |
| CE 3 | 43 | 49 | coh | 8 | coh |
| | | (54) | | | |
| 1 | 38 | 97 | coh | 1423 | coh |
| | | (106) | | | |
| 2 | 43 | 115 | coh | 3591 | coh |
| | | (126) | | | |
| 3 | 48 | 103 | coh | 1477 | coh |
| | | (113) | | | |
| 4 | 43 | 65 | adh | 10,000+ | NA |
| | | (71) | | | |
| 5 | 46 | 70 | adh | 10,000+ | NA |
| | | (77) | | | |
| 6 | 46 | 66 | adh | 10,000+ | NA |
| | | (72) | | | |
| 7 | 46 | 61 | adh | 10,000+ | NA |
| | | (67) | | | |
| 8 | 48 | 74 | adh | 10,000+ | NA |
| | | (81) | | | |
| 9 | 46 | 57 | adh | 10,000+ | NA |
| | | (62) | | | |
| 10 | 43 | 54 | adh | 10,000+ | NA |
| | | (59) | | | |
| 11 | 51 | 56 | adh | 10,000+ | NA |
| | | (61) | | | |
| 12 | 28 | 42 | adh | 7,000 | coh |
| | | (46) | | | |

TABLE 3
Results

| | E1010 | E1020 | IPA | Tan delta |
|---|---|---|---|---|
| Ex. | pbw | pbw | pbw | (° C.) |
| CE 3 | 0 | 0 | 5.0 | −34 |
| 2 | 5 | 0 | 2.0 | −27 |
| 5 | 10 | 0 | 5.0 | −20 |
| 8 | 0 | 5 | 5.0 | −33 |
| 10 | 0 | 10 | 2.0 | −31 |

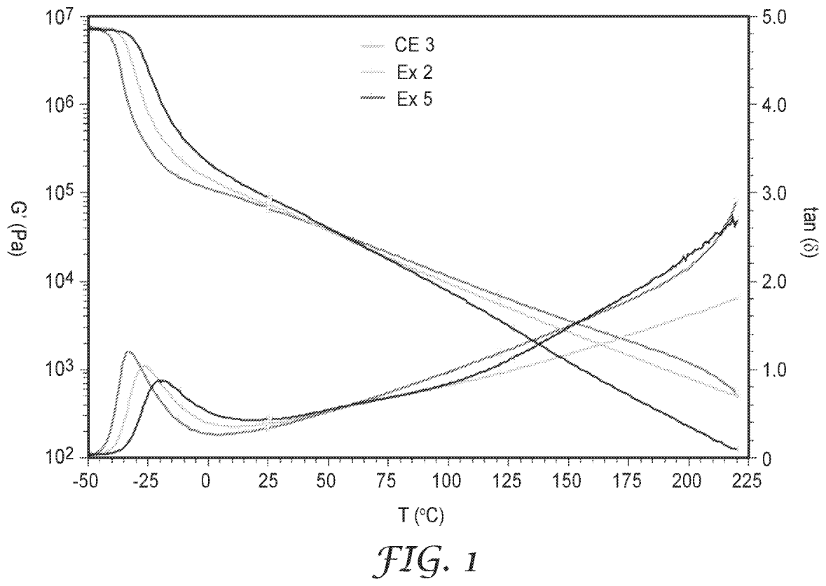

Selected samples from the list above were analyzed by Dynamic mechanical analysis (DMA) methods. FIG. 1 shows DMA spectra for Examples CE-3, 2, and 5 Phase-separation between harder PMMA domains and softer BA domains is expected to result in increased cohesive strength leading to increased shear-holding strength of the PSA. On the contrary, mixing of harder PMMA and softer BA domains is not likely going to contribute to increase in shear-holding strength. Evidence of Mixing will be evident in DMA curves if the tan(delta) peak location (Tg) changes. In FIG. 1, tan(d) or glass transition temperatures of the copolymers progressively increased, which suggest that portions of the PMMA grafts in the acrylic backbone are mixing (instead of phase-separating) with the BA segments/domains. However the data of Table 1 shows that shear strength increases as PMMA % increases in those formulations. That increase is most linked to phase separation of the polymer morphologies. Therefore, the conclusion is that when grafted with PMMA-7K, the formulations do show the benefits of phase-separation and increased shear holding power, but not all of the PMMA grafts are phase separated.

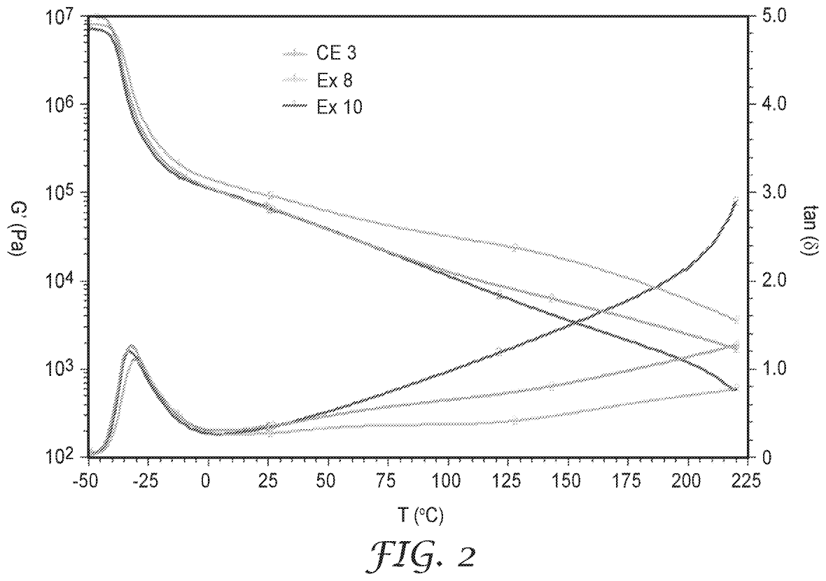

FIG. 2 shows DMA spectra for Examples CE-3, 8, and 10. The formulations in FIG. 1 contained E1010, whereas formulations in FIG. 2 contained E1020. In contrast to FIG. 1, the compositions of FIG. 2 show the tan(delta) locations (T_{g}s) are approximately same for the three formulations, even when % PMMA content increased from 0 to 10% by wt. This suggests that the harder PMMA segments are predominantly phase-separated as distinct hard domains in the polymer matrix, and are not mixing with the softer BA domains. Both formulations Examples 8 and 10 have high shear holding strengths, indicative of the underlying benefits of phase-separation. Even if formulations Example 8 and CE-3 have the same % PMMA, Example formulation 8 has better shear holding strength. Thus increasing the Mw of the grafted PMMA increased the efficiency of phase-separation in these formulations and thus increased the performance of the PSAs.

What is claimed is:

1. A polymerizable composition comprising:
a) a copolymerizable macromer;
b) a (meth)acrylate ester monomer; and
c) a polymerizable type I photoinitiator.

2. The polymer composition of claim 1 wherein the polymerizable type I photoinitiator is of the formula 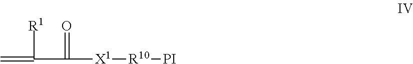
where;
X¹ is —O— or —NR¹,
R¹ is independently H or C₁-C₄ alkyl;
PI is a type I photoinitiator group;
R¹⁰ is a divalent (hetero)hydrocarbyl linking group connecting the (meth)acryloyl group with the PI group.

3. PI is a photoinitiator group of the formula; 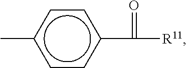
wherein R¹¹ is 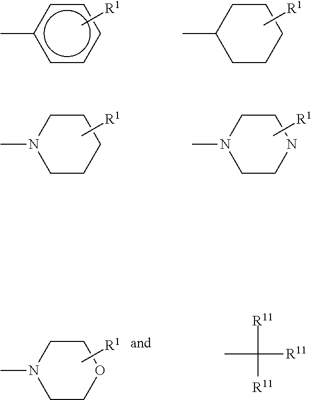
wherein R¹ is H or a C₁ to C₄ alkyl group,
each R¹¹ is independently a hydroxyl group, a phenyl group, a C₁ to C₆ alkyl group, or a C₁ to C₆ alkoxy group.

4. The composition of claim 1 wherein the macromer of the formula
X—(Y)ₙ—Z
wherein X is a vinyl group copolymerizable with the alkyl acrylate and reinforcing monomers;
Y is a divalent linking group where n can be zero or one, and Z is a monovalent polymeric moiety having a Tg greater than 20° C., and a molecular weight in the range of about 2,000 to 30,000.

5. The composition of claim 4 wherein X is of the general formula
RH=R¹—
wherein R is a hydrogen atom or a COOH group and R¹ is a hydrogen atom or methyl group.

6. The composition of claim 4 wherein Z is of the general formula 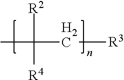
wherein R² is a hydrogen atom or a lower alkyl group, R³ is a lower alkyl group, n is an integer from 20 to 500, and R⁴ is a monovalent radical selected from the group consisting of aryl including substituted aryl and —CO₂R⁶ wherein R⁶ is a lower alkyl group.

7. The composition of claim 1 comprising:
a) 70 to 99 parts by weight of a (meth)acrylate ester monomer;
b) 0.1 to 10 parts a polymerizable type I photoinitiator;
c) 1 to 30 parts by weight of a copolymerizable macromer;
d) Optionally 0.1 to 10 parts be weight of a polar monomer;
wherein a)+b)+c)+d) is 100 parts by weight.

8. The composition of claim 1 comprising:
a) 90 to 99 parts by weight of a (meth)acrylate ester monomer;
b) 0.1 to 1 parts a polymerizable type I photoinitiator;
c) 2 to 10 parts by weight of a copolymerizable macromer;
d) 0.5 to 5 parts be weight of a polar monomer;
wherein a)+b)+c)+d) is 100 parts by weight.

9. The composition of claim 1 wherein the meth)acrylate ester monomer comprises a C₁-C₈ (meth)acrylate.

10. The composition of claim 7 further comprising 0.1 to 5 parts of a polar monomer.

11. The composition of claim 1 wherein the composition further comprises a multifunctional (meth)acrylate.

12. A copolymer of the formula
-[M^{acryl}]ₐ-[M^{PI*}]_{b}-[M^{macro}]_{c+d}*[M^{polar}]ₑ,
where
[M^{acryl}] represents (meth)acrylic monomer units in amounts of subscript a of 70 to 99 parts be weight,
[M^{PI*}] is a monomer unit having a residue of the photoinitiator groups in amounts of subscript b of 0.1 to 10 parts by weight;
[M^{macro}] is the macromer monomer units that are pendent from the MPI* monomer units represented in subscript c amounts or are in-chain represent in subscript d amounts, where c+d is 1 to 30 parts by weight,
[M^{polar}] are optional polar monomer units in amounts subscript e of 0.1 to 10 pats by weight, wherein the sum of the subscripts is 100 parts by weight.

13. A method of preparing an adhesive composition comprising:
a) thermally polymerizing a composition comprising a (meth)acrylate ester monomer; a polymerizable type I photoinitiator and optionally a macromer and optionally a polar monomer in the presence of a thermal initiator to produce a copolymer having pendent photoinitiator groups and optionally pendent and/or terminal macromer groups;
b) optionally adding unreacted macromer if not present in step a);
c) exposing the copolymer of step b) to UV whereby the pendent photoinitiator groups photolyze to initiate polymerization of unreacted macromer.

14. The method of claim 13 wherein step a) further comprises a chain transfer agent having a Cₛ of 10⁻² to 10⁻⁵.

15. The method of claim 13 wherein step a) includes macromer.

16. The method of claim 13 wherein the monomer mixture of step a) comprises
a) 70 to 99 parts by weight of a (meth)acrylate ester monomer;
b) 0.1 to 10 parts a polymerizable type I photoinitiator;
c) 1 to 30 parts by weight of a copolymerizable macromer;
d) optionally 0.1 to 10 parts be weight of a polar monomer;
wherein a)+b)+c)+d) is 100 parts by weight.

17. A method of preparing an adhesive composition comprising:
Photochemically polymerizing a composition comprising
a (meth)acrylate ester monomer; a polymerizable type I photoinitiator, macromer and optionally a polar monomer.

18. The method of claim 16 wherein the monomer mixture comprises a) 70 to 99 parts by weight of a (meth)acrylate ester monomer;
b) 0.1 to 10 parts a polymerizable type I photoinitiator;
c) 1 to 30 parts by weight of a copolymerizable macromer;
d) optionally 0.1 to 10 parts be weight of a polar monomer;
wherein a)+b)+c)+d) is 100 parts by weight.
